(19) United States
(12) Patent Application Publication
(10) Pub. No.: US 2020/0030922 A1
(43) Pub. Date: Jan. 30, 2020

(54) NOVEL HIGH-ENTROPY ALLOY COMPOSITIONS

(71) Applicants: Darryl S. Hammock, Brighton, MI (US); Prabir Chaudhury, Phoenix, AZ (US)

(72) Inventors: Darryl S. Hammock, Brighton, MI (US); Prabir Chaudhury, Phoenix, AZ (US)

(21) Appl. No.: 16/522,359

(22) Filed: Jul. 25, 2019

Related U.S. Application Data
(60) Provisional application No. 62/703,047, filed on Jul. 25, 2018.

(51) Int. Cl. B23K 35/30; C22C 30/00

(52) U.S. Cl. CPC B23K 35/3053; B23K 35/3046; C22C 30/00

(57) ABSTRACT

Novel high-entropy alloy (HEA) compositions are particularly suited to welding applications. The mixtures contain at least the elements nickel, manganese, cobalt, chromium, vanadium, molybdenum, and iron. The % weight of the constituents varies in accordance with the detailed description contained herein, with tolerances in the range of +/−2% and, in some cases, +/−1%. The mixture may also contain a small amount of aluminum with a tolerance in the range of +/−1% or, more preferably, +/−0.5% In accordance with the invention, the compositions above may be integrated into HEA welding products using cored wire and welding electrode manufacturing techniques, preferably starting with vacuum melted rolled alloys. One manufacturing process uses the compositions as an alloyed strip formed around the appropriate ground/crushed alloys to make commercially viable fabricated welding products.

### REFERENCE TO RELATED APPLICATIONS

This application claims the benefit of U.S. Provisional Patent Application Ser. No. 62/703,047, filed Jul. 25, 2019, the entire content of which is incorporated herein by reference.

### FIELD OF THE INVENTION

This invention relates generally to high-entropy alloys and, more particularly, to novel alloy compositions applicable to welding and other uses.

### BACKGROUND OF THE INVENTION

There is no universally agreed-upon definition of a “high-entropy alloy” or HEA. Basically, a HEA is an alloy with multiple elements (typically 5 or more) that remain in solid solution instead of precipitating into multiple phases. As a consequence, there is only one phase constituted by the solid solution, which exhibits a very high entropy of mixing. The elements typically exhibit an atomic concentration between 5 and 35 atomic percent, and may contain minor elements below 5 atomic percent.

Although HEAs have existed since before 2004, research substantially accelerated in the 2010. An overview of HEAs may be found at: Tsai, Ming-Hung, and Jien-Wei Yeh. High-entropy alloys: a critical review. Materials Research Letters 2.3 (2014): 107-123, (“Yeh,” incorporated herein by reference). While Yeh originally defined HEAs as alloys containing at least 5 elements with concentrations between 5 and 35 atomic percent, later research suggested that this definition could be expanded to include alloys that form a solid solution with no intermetallic phases.

HEAs are currently the focus of significant attention in materials science and engineering because they have potentially desirable properties. Some HEAs have considerably better strength-to-weight ratios, with a higher degree of fracture resistance, tensile strength, as well as corrosion and oxidation resistance than conventional alloys.

As discussed in High Entropy Alloys: Development and Applications Steadyman Chikumba and Veeredhi Vasudevea Rao, Nov. 26-27, 2015 Irene, Pretoria (South Africa), due to their low density and high strength, HEAs find application in transportation and energy industries requiring high performance, reliability and endurance in extreme operating conditions. HEAs can be used to protect the surface of machine components and tools because of their high hardness, wear resistance, high-temperature softening resistance, anti-corrosion, and combinations of these properties. HEAs may further be used as coatings for food preservation and cookware due to anticorrosion, anti-oxidation and wear resistance properties. There is also a wider scope for the application of high strength HEAs.

### SUMMARY OF THE INVENTION

This invention resides in novel high-entropy alloy (HEA) compositions particularly suited to welding applications. In accordance with some preferred embodiments, the mixture containing at least the elements nickel, manganese, cobalt, chromium, vanadium, molybdenum, and iron. The % weight of the constituents varies in accordance with the detailed description contained herein, with tolerances in the range of +/−2% and, in some cases, +/−1%.

In alternative embodiments, the mixture may contain a small amount of aluminum with a tolerance in the range of +/−1% or, more preferably, +/−0.5% In accordance with the invention, the compositions above may be integrated into HEA welding products using cored wire and welding electrode manufacturing techniques, preferably starting with vacuum melted rolled alloys. One manufacturing process uses the compositions as an alloyed strip formed around the appropriate ground/crushed alloys to make commercially viable fabricated welding products.

### DETAILED DESCRIPTION OF THE INVENTION

In broad and general terms, this invention resides in various HEA alloy compositions specifically for welding applications. Table I, below, lists nine alloy compositions applicable to the invention. Note that the tolerance is preferably set at +/−2.0%, more preferably +/−1.0%.

To determine optimum compositions for different applications, we measure room temperature and elevated temperature hardness and tensile properties. This allows us to determine the best combinations for (1) high temperature strength and room temperature ductility for forging an die casting applications; (2) room temperature strength and ductility for structural applications; (3) high temperature strength and creep resistance for engine applications; and possibly (4) elevated temperature strength and corrosion resistance for gas and oil applications.

TABLE I
HIGH-ENTROPY ALLOYS FOR WELDING APPLICATIONS

| Alloy# | Element | Ni | Mn | Co | Cr | V | Mo | Al | Fe |
|---|---|---|---|---|---|---|---|---|---|
| 1 | Wt % | 5.12% | 9.58% | 15.42% | 13.61% | 8.88% | 8.38% | 0.00% | 39.02% |
| 2 | Wt % | 4.95% | 9.26% | 19.88% | 17.55% | 8.59% | 16.20% | 0.00% | 23.58% |
| 3 | Wt % | 4.98% | 9.31% | 24.97% | 22.04% | 12.95% | 16.28% | 0.00% | 9.48% |
| 4 | Wt % | 9.95% | 9.30% | 14.97% | 17.62% | 12.94% | 16.27% | 0.00% | 18.95% |
| 5 | Wt % | 10.29% | 9.62% | 20.64% | 22.78% | 8.92% | 8.41% | 0.12% | 19.35% |
| 6 | Wt % | 9.85% | 9.21% | 24.70% | 13.08% | 8.54% | 16.10% | 0.11% | 18.52% |
| 7 | Wt % | 14.91% | 9.29% | 14.96% | 22.01% | 8.62% | 16.25% | 0.11% | 13.96% |
| 8 | Wt % | 14.83% | 9.25% | 19.85% | 13.14% | 12.86% | 16.17% | 0.11% | 13.89% |
| 9 | Wt % | 15.30% | 9.54% | 25.58% | 18.07% | 8.84% | 8.34% | 0.12% | 14.33% |
| Tolerance | Wt % | ±1% | ±1% | ±2% | ±2% | ±1% | ±1% | 0.05% | ±2% |

In accordance with the invention, the embodiments above are integrated into HEA welding products using cored wire and welding electrode manufacturing techniques, preferably starting with vacuum melted rolled alloys. One manufacturing process uses the compositions as an alloyed strip formed around the appropriate ground/crushed alloys to make commercially viable fabricated welding products.

1. A high-entropy alloy for welding applications, comprising:
a mixture containing at least the following elements:
nickel,
manganese,
cobalt,
chromium,
vanadium,
molybdenum, and
iron.

2. The high-entropy alloy of claim 1, including the following amounts of the elements by percent weight, each with a tolerance in the range of +/−2%:

| | |
|---|---|
| 5.12% | nickel, |
| 9.58% | manganese, |
| 15.42% | cobalt, |
| 13.61% | chromium, |
| 8.88% | vanadium, |
| 8.38% | molybdenum, and |
| 39.02% | iron. |

3. The high-entropy alloy of claim 1, including the following amounts of the elements by percent weight, each with a tolerance in the range of +/−2%:

| | |
|---|---|
| 4.95% | nickel, |
| 9.26% | manganese, |
| 19.88% | cobalt, |
| 17.55% | chromium, |
| 8.59% | vanadium, |
| 16.20% | molybdenum, and |
| 23.58% | iron. |

4. The high-entropy alloy of claim 1, including the following amounts of the elements by percent weight, each with a tolerance in the range of +/−2%:

| | |
|---|---|
| 4.98% | nickel, |
| 9.31% | manganese, |
| 24.97% | cobalt, |
| 22.04% | chromium, |
| 12.95% | vanadium, |
| 16.28% | molybdenum, and |
| 9.48% | iron. |

5. The high-entropy alloy of claim 1, including the following amounts of the elements by percent weight, each with a tolerance in the range of +/−2%:

| | |
|---|---|
| 9.95% | nickel, |
| 9.30% | manganese, |
| 14.97% | cobalt, |
| 17.62% | chromium, |
| 12.94% | vanadium, |
| 16.27% | molybdenum, and |
| 18.95% | iron. |

6. The high-entropy alloy of claim 1, further including 0.11 to 0.12% aluminum with a tolerance in the range of +/−05%:

7. The high-entropy alloy of claim 6, including the following amounts of elements by percent weight, each with a tolerance in the range of +/−2%:

| | |
|---|---|
| 10.29% | nickel, |
| 9.62% | manganese, |
| 20.64% | cobalt, |
| 22.78% | chromium, |
| 8.92% | vanadium, |
| 8.41% | molybdenum, and |
| 19.35% | iron. |

8. The high-entropy alloy of claim 6, including the following amounts of elements by percent weight, each with a tolerance in the range of +/−2%:

| | |
|---|---|
| 9.85% | nickel, |
| 9.21% | manganese, |
| 24.70% | cobalt, |
| 13.08% | chromium, |
| 8.54% | vanadium, |
| 16.10% | molybdenum, and |
| 18.52% | iron. |

9. The high-entropy alloy of claim 6, including the following amounts of elements by percent weight, each with a tolerance in the range of +/−2%:

| | |
|---|---|
| 14.91% | nickel, |
| 9.29% | manganese, |
| 14.96% | cobalt, |
| 22.01% | chromium, |
| 8.62% | vanadium, |
| 16.25% | molybdenum, and |
| 13.96% | iron. |

10. The high-entropy alloy of claim 6, including the following amounts of elements by percent weight, each with a tolerance in the range of +/−2%:

| | |
|---|---|
| 14.83% | nickel, |
| 9.25% | manganese, |
| 19.85% | cobalt, |
| 13.14% | chromium, |
| 12.86% | vanadium, |
| 16.17% | molybdenum, and |
| 13.89% | iron. |

11. The high-entropy alloy of claim 6, including the following amounts of elements by percent weight, each with a tolerance in the range of +/−2%:

| | |
|---|---|
| 15.30% | nickel, |
| 9.54% | manganese, |
| 25.58% | cobalt, |
| 18.07% | chromium, |
| 8.84% | vanadium, |
| 8.34% | molybdenum, and |
| 14.33% | iron. |

12. The high-entropy alloy of claim 1, wherein the welding product is fabricated using a cored-wire manufacturing process.

13. The high-entropy alloy of claim 12, wherein the cored-wire manufacturing process comprises an alloyed strip formed around the high-entropy alloy in ground or crushed form.
